(19) United States
(12) Patent Application Publication
(10) Pub. No.: US 2021/0222365 A1
(43) Pub. Date: Jul. 22, 2021

(54) METHOD AND SYSTEM FOR APPLYING A MULTI-LAYER COATING

(71) Applicant: WestRock MWV, LLC, Atlanta, GA (US)

(72) Inventors: Sergio A. Giuste, Midlothian, VA (US); Steven G. Bushhouse, Quinton, VA (US); Jiebin Pang, Glen Allen, VA (US); Brian K. Knapp, West Point, VA (US)

(21) Appl. No.: 16/749,377

(22) Filed: Jan. 22, 2020

(51) Int. Cl. D21H 23/70; D21H 25/08; D21H 23/40; D21H 23/56; B05C 1/08; B05C 3/18; B05D 1/28; B05D 1/36

(52) U.S. Cl. CPC D21H 5/0052; D21H 5/0062; D21H 5/0015; D21H 5/003; B05D 2203/22; B05C 3/18; B05D 1/28; B05D 1/36; B05C 1/083

(57) ABSTRACT

A method for applying a multi-layer coating includes passing a substrate through a nip defined by two rolls to apply a first thickness of a first liquid coating material, applying a second liquid coating material on the first liquid coating material having the first thickness as applied by passing through the nip, and controlling a thickness of the applied second liquid coating material.

### FIELD

The present application relates to the field of coatings and, more particularly, to systems and methods for applying multi-layer coatings onto substrates, such as paper or paperboard substrates.

### BACKGROUND

Typical systems and methods for applying two coating layers onto a paperboard substrate utilize two coating units, including drying and web handling components for each unit, resulting in significant capital expenditures for each unit, as well as operating and maintenance costs for each unit.

Accordingly, those skilled in the art continue with research and development in the field of coating systems and methods.

### SUMMARY

Disclosed are methods for applying a multi-layer coating onto a substrate, such as a paper or paperboard substrate.

In one example, the disclosed method for applying a multi-layer coating includes passing a substrate through a nip defined by two rolls to apply a first thickness of a first liquid coating material, applying a second liquid coating material on the first liquid coating material having the first thickness as applied by passing through the nip, and controlling a thickness of the applied second liquid coating material.

Also disclosed are systems for applying a multi-layer coating onto a substrate, such as a paper or paperboard substrate.

In one example, the disclosed multi-layer coating system includes a nip defined by two rolls. The nip is configured to apply a first thickness of a first liquid coating material to a substrate passing through the nip. The system further includes a topcoat applicator configured to apply a second liquid coating material on the first liquid coating material having the first thickness as applied by passing through the nip and a postmetering surface configured to control a thickness of the applied second liquid coating material.

Other examples of the disclosed method and system for applying a multi-layer coating will become apparent from the following detailed description, the accompanying drawings and the appended claims.

### BRIEF DESCRIPTION OF THE DRAWINGS

FIG. 1 is an example representation of a cross-section of a multi-layer coating system in accordance with the present disclosure.

FIG. 2 is a representation of a cross-section of an exemplary substrate prior to coating.

FIG. 3 is a representation of a cross-section of the exemplary substrate after applying a first liquid coating material.

FIG. 4 is a representation of a cross-section of the exemplary substrate after applying a second liquid coating material.

### DETAILED DESCRIPTION

By reference herein to a “multi-layer” coating system and a “multi-layer” coating, it will be understood that the resulting coatings may include two layers or more than two layers. In other words, the multi-layer coating may include two layers, though third or additional coating layers may be applied before, during, or after utilization of the coating system and method herein described.

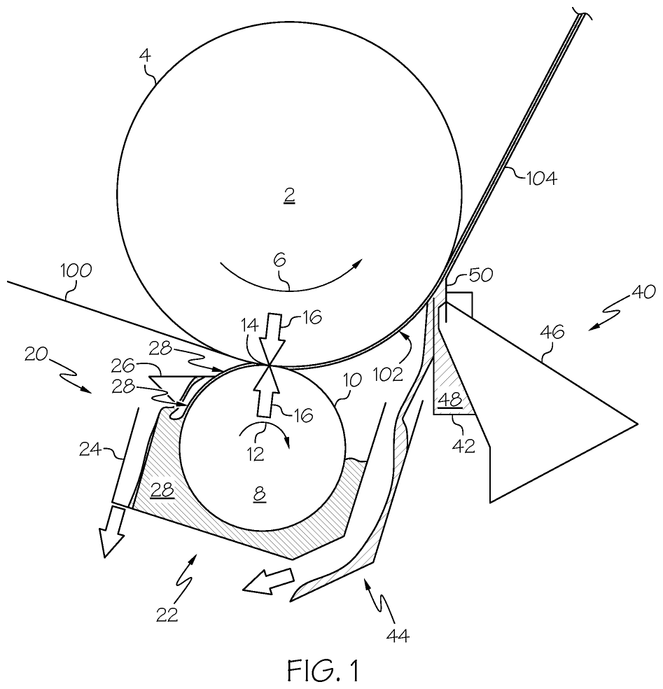

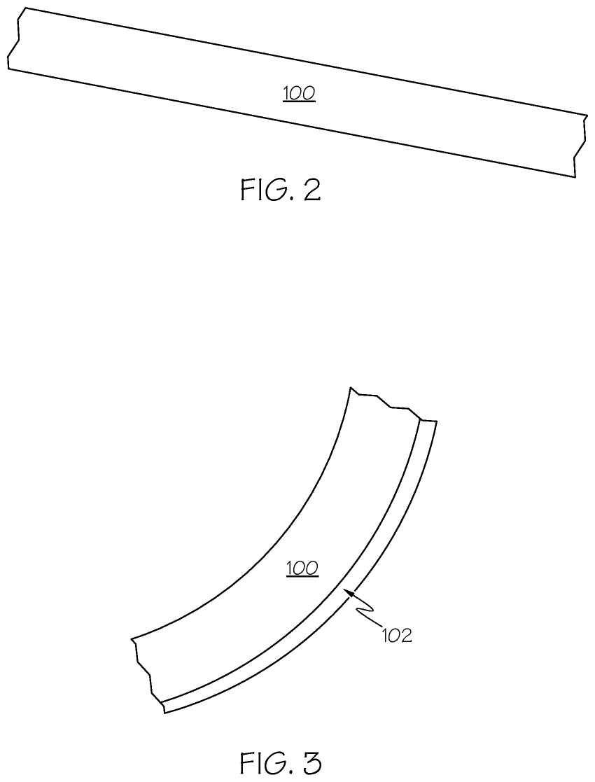

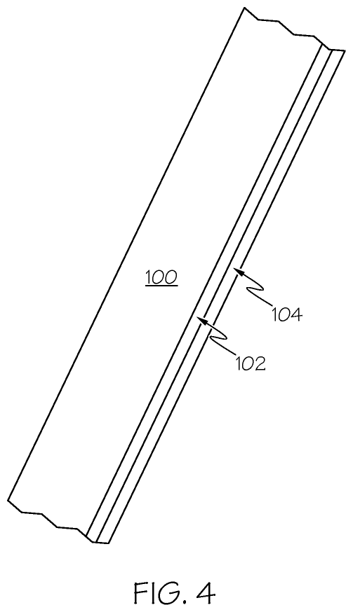

FIG. 1 illustrates an exemplary multi-layer coating system in accordance with the present disclosure. FIG. 2 illustrates a cross-section of an exemplary substrate 100 prior to coating. FIG. 3 is a illustrates a cross-section of the substrate 100 after applying a first liquid coating material 102 thereon. FIG. 4 illustrates a cross-section of the substrate 100 after applying a second liquid coating material 104 on the first liquid coating material 102.

As shown in FIG. 1, the multi-layer coating system may include a backing roll 2 having an outer cylindrical surface 4. The backing roll 2 may be rotatably driven at a first driving speed 6 in a direction of travel of a substrate 100 to drive the substrate 100 in its direction of travel along the outer cylindrical surface 4 of a backing roll 2.

Returning to FIG. 1, the multi-layer coating system may include an applicator roll 8 having an outer cylindrical surface 10. The applicator roll 8 may be rotatably driven at a second driving speed 12 in a direction of travel of the substrate 100.

The outer cylindrical surface 10 of the applicator roll 8 may be positioned adjacent to the outer cylindrical surface 4 of the backing roll 2 to define a nip 14 therebetween for passing the substrate 100 therethrough.

By driving the applicator roll 8, a first liquid coating material 28 on the outer cylindrical surface 10 of the applicator roll 8 may be applied to the substrate 100 passing through the nip 14.

The first liquid coating material 28 may be provided to the outer cylindrical surface 10 of the applicator roll 8 in any manner. For example, as shown in FIG. 1, the multi-layer coating system may include a first coating system 20 for providing the first liquid coating material 28 to the outer cylindrical surface 10 of the applicator roll 8. The first coating system 20 may include, for example, an applicator roll pan 22 for holding the first liquid coating material 28. The applicator roll pan 22 may be positioned such that the first liquid coating material 28 held within the applicator roll pan 22 contacts the outer cylindrical surface 10 of the applicator roll 8 in advance of the outer cylindrical surface 10 of the applicator roll 8 traveling to the nip 14. However, other devices and methods for providing first liquid coating material 28 to the outer cylindrical surface 10 of the applicator roll 8 may be utilized. The first coating system 20 may further include a first coating return 24 for removing an excess portion of the first liquid coating material 28 and recirculating the first liquid coating material 28

The amount of the first liquid coating material 28 provided to the outer cylindrical surface 10 of applicator roll 8 and applied to the substrate 100 may be have improved control by premetering a thickness of the first liquid coating material 28 provided on the outer cylindrical surface 10 of the applicator roll 8. For example, as shown in FIG. 1, the premetering may include positioning a premetering surface 26, such as a rod, a blade, or any other premetering device, adjacent to the outer cylindrical surface 10 of the applicator roll 8 to define a premetered thickness of the first liquid coating material on the outer cylindrical surface 10 of the applicator roll 8 in advance of the outer cylindrical surface 10 of the applicator roll 8 traveling to the nip 14. However, other devices and methods for pre-metering the first liquid coating material 28 to the outer cylindrical surface 10 of the applicator roll 8 may be utilized. By premetering the thickness of the first liquid coating material 28 provided on the outer cylindrical surface 10 of the applicator roll 8, the resulting thickness of the first liquid coating material 28 applied to the substrate 100 may be better controlled.

In an aspect, the substrate 100 passing through the nip 14 defined between the outer cylindrical surface 4 of the backing roll 2 and the outer cylindrical surface 10 of the applicator roll 8 may be compressed therebetween. The pressure applied between the backing roll 2 and the applicator roll 8 may be, for example, a compressive pressure in a range of 5 to 150 pounds per linear inch. By applying a compressive force 16 between the outer cylindrical surface 4 of the backing roll 2 and the outer cylindrical surface 10 of the applicator roll 8, a method of the present description is facilitated, in which the substrate may be passed through the nip to apply a first thickness of a first liquid coating material, in which the first thickness of the first liquid coating material is maintained during a subsequent step of applying a second liquid coating material on the first liquid coating material, without necessitating a subsequent metering of the first liquid coating material. In particular, the first liquid coating material 28 may be more immobilized against the substrate 100 by the compressive force 16, facilitating the application of the second liquid coating material 48 on the first liquid coating material 28 without necessitating subsequent metering or drying of the first liquid coating material 28 and without significantly disturbing the first liquid coating material 28.

In another aspect, the first driving speed the outer cylindrical surface 10 of the applicator roll 8 may be substantially the same as the driving speed of the substrate and/or backing roll 2. In an example, a driving speed of the outer cylindrical surface 10 of the applicator roll 8 may be within 10% of a driving speed of the substrate 200 and/or backing roll 2. In another example, a driving speed of the outer cylindrical surface 10 of the applicator roll 8 may be within 5% of a driving speed of the substrate 200 and/or backing roll 2. In yet another example, a driving speed of the outer cylindrical surface 10 of the applicator roll 8 may be within 2% of a driving speed of the substrate 200 and/or backing roll 2. In yet another example, a driving speed of the outer cylindrical surface 10 of the applicator roll 8 may be within 1% of a driving speed of the substrate 200 and/or backing roll 2. In yet another example, a driving speed of the outer cylindrical surface 10 of the applicator roll 8 may be within 0.1% of a driving speed of the substrate 200 and/or backing roll 2.

By driving the outer cylindrical surface 10 of the applicator roll 8 at substantially the same as the driving speed of the substrate and/or backing roll 2, a method of the present description is facilitated, in which the substrate may be passed through the nip to apply a first thickness of a first liquid coating material, in which the first thickness of the first liquid coating material is maintained during a subsequent step of applying a second liquid coating material on the first liquid coating material, without necessitating a subsequent metering of the first liquid coating material. In particular, the first liquid coating material 28 may be more immobilized against the substrate 100, facilitating the application of the second liquid coating material 48 on the first liquid coating material 28 without necessitating subsequent metering or drying of the first liquid coating material 28 and without significantly disturbing the first liquid coating material 28.

By avoiding the need for intermediate metering, the method and system of the present description may be simplified. By avoiding the need for intermediate drying, detrimental effects through shrinkage for the first liquid coating material 28 may be avoided.

In a specific example, the substrate 100 passing through the nip 14 defined between the outer cylindrical surface 4 of the backing roll 2 and the outer cylindrical surface 10 of the applicator roll 8 is compressed therebetween and the outer cylindrical surface 10 of the applicator roll 8 and is driven at a substantially the same as the driving speed of the substrate and/or backing roll 2 to immobilize the first liquid coating material 28 against the substrate 100.

Referring to FIG. 3, after passing through the nip 14, the substrate 100 includes a first thickness of a first liquid coating material 102 thereon. The first liquid coating material 102 does not necessitate intermediate metering or drying prior to application of the second liquid coating material 48 thereon.

Returning to FIG. 1, the multi-layer coating system may include a topcoat applicator 40 applying a second liquid coating material 48 on the substrate 100 coated with the first liquid coating material 102. The topcoat applicator 40 may include any device suitable for applying the second liquid coating material 48 while the substrate is positioned on the outer cylindrical surface 4 of a backing roll 2. By way of example, the topcoat applicator 40 may comprise a spray coater or a short dwell coater. As shown in FIG. 1, the exemplary topcoat applicator 40 includes a coating distribution chamber 42 holding second liquid coating material 48 therein. The second liquid coating material 48 is overflowed or sprayed onto the substrate 100 coated with the first liquid coating material 102 in an excessive amount. The topcoat applicator 40 may further include a second coating return 44 for removing an excess portion of the second liquid coating material 48.

At this point, those skilled in the art will appreciate that the second liquid coating material 48 applied by the topcoat applicator 40 need not be the final (i.e., top-most) coating applied to the substrate 100. Additional layers of coating material may be applied over the second liquid coating material 48 without departing from the scope of the present disclosure.

The system and method of the present disclosure may further control an amount of the second liquid coating material applied on the substrate 100. Particularly, a thickness of the second liquid coating material applied on the substrate may be controlled. For example, as shown in FIG. 1, the system may include a postmetering surface 50 positioned adjacent to the outer cylindrical surface 4 of the backing roll 2 to control a thickness of the second liquid coating material applied on the substrate 100. By way of example, the postmetering surface 50 may be in the form of a rod, a blade, an air knife, or any other premetering device. As shown in FIG. 1, the postmetering surface 50 may be held in a controlled position by a support, such as by way of blade beam 46.

In an aspect, as shown in FIG. 1, the thickness of the second liquid coating material may be controlled while the substrate is positioned on the outer cylindrical surface of a backing roll.

In an aspect, the thickness of the second liquid coating material applied on the substrate is controlled by removing an excessive amount of the second liquid coating material applied on the substrate 100 by the topcoat applicator 40. The topcoat applicator 40 does not necessitate application of a controlled amount of the second liquid coating material 48.

Referring to FIG. 4, after controlling the thickness of the second liquid coating material applied on the substrate 100, the substrate 100 includes a first thickness of a first liquid coating material 102 and a second thickness of a second liquid coating material 104.

The first and second liquid coating materials are not yet in a dried state. The system and method of the present disclosure may further include drying the first and second liquid coating materials applied on the substrate. The method and devices for drying the first and second liquid coating materials are not limited.

The substrate 100 may be any suitable substrate material capable of being used with the exemplary system and method. As one specific, non-limiting example, the substrate 100 may be a paper substrate. As another specific, non-limiting example, the substrate 100 may be a paperboard substrate The paperboard substrate may be any web of fibrous material that is capable of being coated. The paperboard substrate may be bleached or unbleached, and may have an uncoated basis weight of about 85 pounds per 3000 ft² or more. The paperboard substrate may be bleached or unbleached may be formed from virgin fibers, recycled fibers, or combinations thereof. Examples of appropriate paperboard substrates include corrugating medium, linerboard, solid bleached sulfate (SBS), secondary fiber such as recyclable, cup-stock and plate base paperboard, aseptic liquid packaging paperboard, and a combination of such materials.

Any substrate suitable liquid coating materials may be utilized for the first and second liquid coating materials. For example, the liquid coating materials may be paper or paperboard coatings, such as coatings containing pigment (e.g., clay and/or calcium carbonate) and binder (e.g., latex).

The first liquid coating material may have a different composition than the second liquid coating material. The coating system and method as described above enables for applying first and second coating layer having different compositions without necessitating separate coating units. However, the coating system and method is not limited to utilization of different coating materials. Thus, the first liquid coating material may have the same composition than the second liquid coating material.

By way of example, the first liquid coating material 28 may include an aqueous-based coating material. However, the first liquid coating material may include a solvent-based coating material.

By way of example, the second liquid coating material 48 may include an aqueous-based coating material. However, the second liquid coating material may include a solvent-based coating material.

Although various examples of the disclosed multi-layer coating system and method for applying a multi-layer coating have been shown and described, modifications may occur to those skilled in the art upon reading the specification. The present application includes such modifications and is limited only by the scope of the claims.

What is claimed is:

1. A method for applying a multi-layer coating, the method comprising:
passing a substrate through a nip defined by two rolls to apply a first thickness of a first liquid coating material;
applying a second liquid coating material on the first liquid coating material having the first thickness as applied by passing through the nip; and
controlling a thickness of the applied second liquid coating material.

2. The method of claim 1 further comprising applying a compression force to the substrate while passing through the nip.

3. The method of claim 2 wherein the compression force applied to the substrate while passing through the nip is in a range of 5-150 pounds per linear inch.

4. The method of claim 1 wherein passing the substrate through the nip defined by two rolls to apply the first thickness of the first liquid coating material comprises:
driving the substrate in a direction of travel along an outer cylindrical surface of a backing roll;
contacting an outer cylindrical surface of an applicator roll with the first liquid coating material; and
driving the coated outer cylindrical surface of the applicator roll into contact with the substrate.

5. The method of claim 4 wherein a rotation speed of the outer cylindrical surface of the applicator roll is within 10% of the speed of the substrate passing through the nip.

6. The method of claim 4 wherein a rotation speed of the outer cylindrical surface of the applicator roll is within 5% of the speed of the substrate passing through the nip.

7. The method of claim 4 wherein a rotation speed of the outer cylindrical surface of the applicator roll is within 2% of the speed of the substrate passing through the nip.

8. The method of claim 4 wherein a rotation speed of the outer cylindrical surface of the applicator roll is within 1% of the speed of the substrate passing through the nip.

9. The method of claim 4 further comprising premetering a thickness of the first liquid coating material contacted on the outer cylindrical surface of the applicator roll in advance of the outer cylindrical surface of the applicator roll traveling to the nip.

10. The method of claim 4 wherein the second liquid coating material is applied on the substrate while the substrate is positioned on the outer cylindrical surface of the backing roll.

11. The method of claim 4 wherein the thickness of the applied second liquid coating material is controlled while the substrate is positioned on the outer cylindrical surface of the backing roll.

12. The method of claim 1 wherein controlling the thickness of the applied second liquid coating material comprises removing an excessive amount of the applied second liquid coating material.

13. The method of claim 1 further comprising drying the applied first and second liquid coating materials.

14. A multi-layer coating system comprising:
a nip defined by two rolls, wherein the nip is configured to apply a first thickness of a first liquid coating material to a substrate passing through the nip;
a topcoat applicator configured to apply a second liquid coating material on the first liquid coating material having the first thickness as applied by passing through the nip;
a postmetering surface configured to control a thickness of the applied second liquid coating material.

15. The system of claim 14 wherein the two rolls include:
a backing roll rotatably driven in a direction of travel of the substrate, the backing roll having an outer cylindrical surface; and
an applicator roll having an outer cylindrical surface rotatably driven in the direction of travel of the substrate, wherein the outer cylindrical surface of the applicator roll is positioned adjacent to the outer cylindrical surface of the backing roll to define the nip therebetween for applying the first thickness of the first liquid coating material to the substrate passing through the nip.

16. The system of claim 15 further comprising an applicator roll pan configured to hold a first liquid coating material that contacts the outer cylindrical surface of the applicator roll in advance of the outer cylindrical surface of the applicator roll traveling to the nip.

17. The system of claim 15 further comprising a premetering surface positioned adjacent to the outer cylindrical surface of the applicator roll configured to define a premetered thickness of the first liquid coating material on the outer cylindrical surface of the applicator roll in advance of the outer cylindrical surface of the applicator roll traveling to the nip.

18. The system of claim 17 wherein the premetering surface is in the form of a rod or a blade.

19. The system of claim 14 further comprising a first coating return configured to remove an excess portion of the first liquid coating material.

20. The system of claim 14 wherein the topcoat applicator comprises a spray coater.

21. The system of claim 14 wherein the topcoat applicator comprises a short dwell coater.

22. The system of claim 14 further comprising a second coating return configured to remove an excess portion of the second liquid coating material.

23. The system of claim 14 wherein the postmetering surface is in the form of a rod, a blade, or an air knife.
